(19) United States
(12) Patent Application Publication
(10) Pub. No.: US 2018/0329621 A1
(43) Pub. Date: Nov. 15, 2018

(54) Object Insertion

(71) Applicant: Microsoft Technology Licensing, LLC, Redmond, WA (US)

(72) Inventors: Eduardo SONNINO, Vancouver (CA); Anthony DART, Redmond, WA (US); Andrew Michael CASEY, Redmond, WA (US); March ROGERS, Bothell, WA (US); Jenny Angelica ALARCO DIEZ, Seattle, WA (US)

(73) Assignee: Microsoft Technology Licensing, LLC, Redmond, WA (US)

(21) Appl. No.: 15/638,101

(22) Filed: Jun. 29, 2017

Related U.S. Application Data
(60) Provisional application No. 62/506,479, filed on May 15, 2017.

(51) Int. Cl. G06F 3/0488; G06F 3/0482

(52) U.S. Cl. CPC G06F 3/04883; G06F 3/03545; G06F 3/0482

(57) ABSTRACT

Techniques for object insertion are described. In one or more implementations, digital content is generated as an interactive canvas, and the interactive canvas is displayed on one or more display devices of a computing device. User input is received to the interactive canvas and the user input is detected as corresponding to a closed shape. In response to detecting that the user input corresponds to the closed shape, the user input is digitized and displayed as additional digital content on the interactive canvas and an object insertion mode is initiated by displaying an object insertion menu on the interactive canvas. In response to selection of an object from the object insertion menu, the selected object is inserted into the interactive canvas within the closed shape.

### RELATED APPLICATION

This application claims priority to U.S. Provisional Application No. 62/506,479, filed May 15, 2017, entitled “Object Insertion”, the disclosure of which is hereby incorporated by reference herein in its entirety.

### BACKGROUND

Increasingly, users interact with devices by providing user input to touch displays using a stylus or the user's finger. Using a stylus makes it easy for the user to provide “free-form” input to the display device, such as by writing or drawing on the display device. However, when the primary input device used to interact with the device is a stylus or the user's finger, it can be difficult for users to initiate other functions, such as accessing menus to insert objects or content into a canvas. Furthermore, on devices with smaller displays (e.g., a smartphone or tablet), the display of a menu to insert content into a canvas takes up valuable screen space which could be otherwise utilized by the user to create content.

### SUMMARY

Techniques for object insertion are described. In one or more implementations, digital content is generated as an interactive canvas, and the interactive canvas is displayed on one or more display devices of a computing device. User input is received to the interactive canvas and the user input is detected as corresponding to a closed shape. In response to detecting that the user input corresponds to the closed shape, the user input is digitized and displayed as additional digital content on the interactive canvas and an object insertion mode is initiated by displaying an object insertion menu on the interactive canvas. In response to selection of an object from the object insertion menu, the selected object is inserted into the interactive canvas within the closed shape.

In one or more implementations, digital content is generated as an interactive canvas, and the interactive canvas is displayed on one or more display devices of a computing device along with one or more objects. User input is received to the interactive canvas, and the user input is detected as corresponding to a closed shape and that one or more objects are within the closed shape. In response to detecting that the user input corresponds to a closed shape and that one or more objects are within the closed shape, one or more controls are displayed that are selectable to perform one or more respective operations on the one or more objects within the closed shape.

In one or more implementations, user input is received to an interactive canvas and the user input is detected as corresponding to a closed shape. In response to detecting that the user input corresponds to the closed shape, an object insertion menu is displayed on the interactive canvas. The object insertion menu includes selectable representations corresponding to multiple different object types which may be inserted into the interactive canvas within the closed shape. In response to receiving a user selection of a selectable representation associated with an object type from the object insertion menu, an object insertion control associated with the selected object type is displayed in the object insertion menu. The object insertion control includes additional selectable representations corresponding to objects associated with the selected object type which are selectable to insert a respective object into the interactive canvas within the closed shape.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment 100 in an example implementation that is operable to employ techniques for object insertion discussed herein.

FIG. 2 illustrates a system showing the object insertion module of FIG. 1 in more detail.

FIGS. 3A-3F illustrate various examples of object insertion in accordance with one or more implementations.

FIG. 4 which illustrates an example of drawing a closed shape around one or more objects.

FIG. 5 is a flow diagram that describes steps in a method for inserting objects into an interactive canvas in accordance with one or more implementations.

FIG. 6 is a flow diagram that describes steps in a method for displaying one or more controls that are selectable to perform operations on objects within a closed shape.

FIG. 7 is a flow diagram that describes steps in a method for displaying an object insertion menu in response to detecting user input corresponding to a closed shape in accordance with one or more implementations.

FIG. 8 illustrates an example system that includes an example computing device that is representative of one or more computing systems and/or devices that may implement the various techniques described herein.

### DETAILED DESCRIPTION

Techniques for object insertion are described. In one or more implementations, digital content is generated as an interactive canvas, and the interactive canvas is displayed on one or more display devices. An object insertion module monitors for user input to an interactive canvas, and detects user input to the interactive canvas corresponding to a closed shape. In response to detection of the user input corresponding to the closed shape, the user input is digitized and displayed as digital content on the interactive canvas and an object insertion mode is initiated by dynamically displaying an object insertion menu on the interactive canvas. In one or more implementations, the object insertion menu is not displayed unless the closed shape is above a certain size threshold. The object insertion menu, for example, may include selectable representations associated with various types of objects or content, such as images, videos, audio files, text, and so forth. In response to selection of an object from the object insertion menu, the selected object is inserted into the interactive canvas within the closed shape.

Thus, the described techniques improve a user experience by enabling the quick and efficient insertion of objects into an interactive canvas. Additionally, displaying the object insertion menu dynamically and in response to detection of a closed shape maximizes screen space that can be utilized by the user to create, particularly as compared to conventional solutions which persistently display menu items.

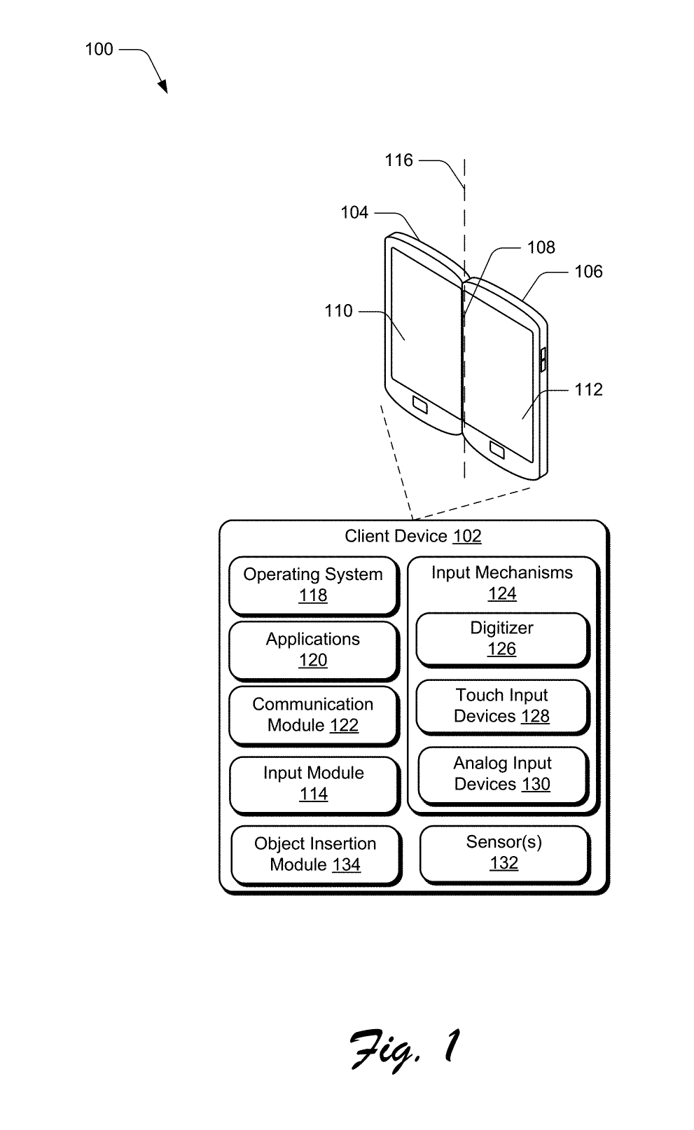

FIG. 1 is an illustration of an environment 100 in an example implementation that is operable to employ techniques for object insertion discussed herein. Environment 100 includes a client device 102 which can be configured for mobile use, such as a mobile phone, a tablet computer, a wearable device, a handheld gaming device, a media player, and so on. In this example, the client device 102 is implemented as a “dual-display” device, and includes a display device 104 and a display device 106 that are connected to one another by a hinge 108. The display device 104 includes a touch surface 110, and the display device 106 includes a touch surface 112. The client device 102 also includes an input module 114 configured to process input received via one of the touch surfaces 110, 112 and/or via the hinge 108. While some of the techniques discussed herein will be described with reference to a dual-display device, it is to be appreciated that in some cases the techniques may also be implemented on a single-screen device, such as a mobile phone, tablet computer, media player, laptop computer, desktop computer, and so forth. In addition, the hinge 108 may allow the display devices 104 and 106 to fold back on each other to provide a “single display” device. As such, the techniques described herein may be designed to function whether the user is operating in a two-display mode or a single-display mode. In addition, while the dual display device is illustrated with a hinge in this example, it is to be appreciated that in some cases the techniques may be implemented in single display, dual-display, or multi-display devices without the hinge.

The hinge 108 is configured to rotationally move about a longitudinal axis 116 of the hinge 108 to allow an angle between the display devices 104, 106 to change. In this way, the hinge 108 allows the display devices 104, 106 to be connected to one another yet be oriented at different angles and/or planar orientations relative to each other. In at least some implementations, the touch surfaces 110, 112 may represent different portions of a single integrated and continuous display surface that can be bent along the hinge 108.

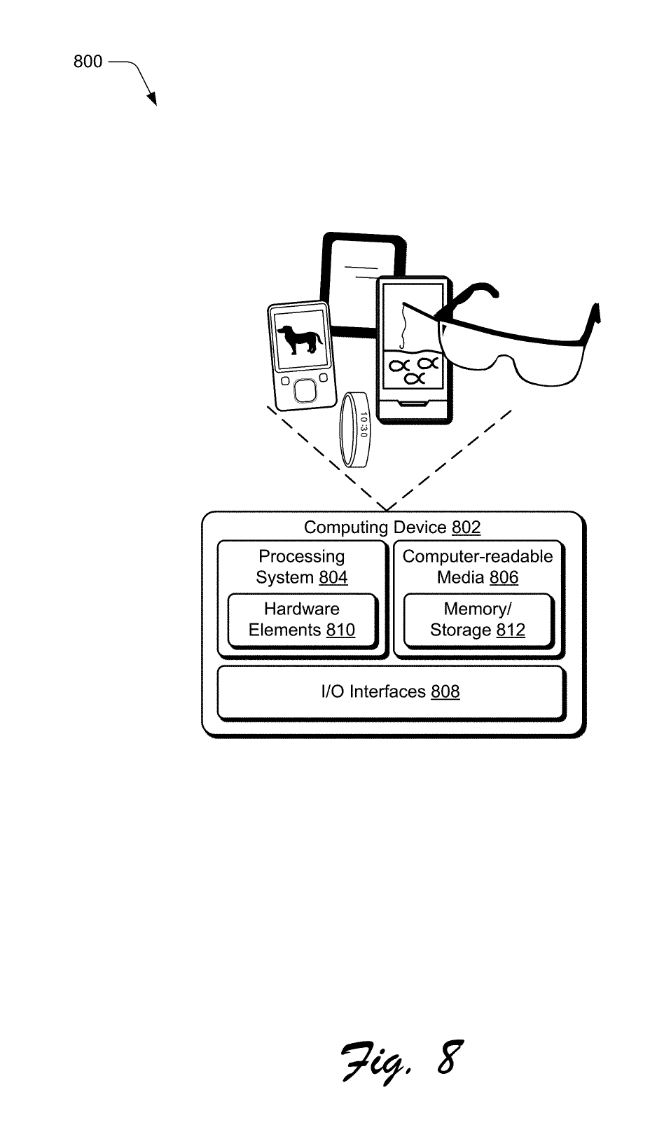

While implementations presented herein are discussed in the context of a mobile device, it is to be appreciated that various other types and form factors of devices may be utilized in accordance with the claimed implementations. Thus, the client device 102 may range from full resource devices with substantial memory and processor resources, to a low-resource device with limited memory and/or processing resources. An example implementation of the client device 102 is discussed below with reference to FIG. 8.

The client device 102 includes a variety of different functionalities that enable various activities and tasks to be performed. For instance, the client device 102 includes an operating system 118, applications 120, and a communication module 122. Generally, the operating system 118 is representative of functionality for abstracting various system components of the client device 102, such as hardware, kernel-level modules and services, and so forth. The operating system 118, for instance, can abstract various components (e.g., hardware, software, and firmware) of the client device 102 to enable interaction between the components and applications running on the client device 102.

The applications 120 are representative of functionality for performing different tasks via the client device 102. In one particular implementation, the applications 120 represent a web browser, web platform, or other application that can be leveraged to browse websites over a network.

The communication module 122 is representative of functionality for enabling the client device 102 to communicate over wired and/or wireless connections. For instance, the communication module 122 represents hardware and logic for communicating data via a variety of different wired and/or wireless technologies and protocols.

According to various implementations, the display devices 104, 106 generally represent functionality for visual output for the client device 102. Additionally, the display devices 104, 106 represent functionality for receiving various types of input, such as touch input, stylus input, touchless proximity input, and so forth via one or more of the touch surfaces 110, 112, which can be used as visual output portions of the display devices 104, 106. The input module 114 is representative of functionality to enable the client device 102 to receive input (e.g., via input mechanisms 124) and to process and route the input in various ways.

The input mechanisms 124 generally represent different functionalities for receiving input to the client device 102, and include a digitizer 126, touch input devices 128, and analog input devices 130. Examples of the input mechanisms 124 include gesture-sensitive sensors and devices (e.g., such as touch-based sensors), a stylus, a touch pad, accelerometers, a microphone with accompanying voice recognition software, and so forth. The input mechanisms 124 may be separate or integral with the display devices 104, 106; integral examples include gesture-sensitive displays with integrated touch-sensitive sensors.

The digitizer 126 represents functionality for converting various types of input to the display devices 104, 106, the touch input devices 128, and the analog input devices 130 into digital data that can be used by the client device 102 in various ways, such as by displaying digital content corresponding to the user input. The analog input devices 130 represent hardware mechanisms (e.g., the hinge 108) that are usable to generate different physical quantities that represent data. For instance, the hinge 108 represents a mechanism that can be leveraged to generate input data by measurement of a physical variable, such as hinge angle of the hinge 108. One or more sensors 132, for example, can measure the hinge angle, and the digitizer 126 can convert such measurements into digital data usable by the client device 102 to perform operations to digital content displayed via the display devices 104, 106.

Generally, the sensors 132 represent functionality for detecting different input signals received by the client device 102. For example, the sensors 132 can include one or more hinge sensors configured to detect a hinge angle between the display devices 104, 106. Additionally, the sensors 132 can include grip sensors, such as touch sensors, configured to detect how a user is holding the client device 102. Accordingly, a variety of different sensors 132 can be implemented to detect various different types of digital and/or analog input. These and other aspects are discussed in further detail below.

In one particular implementation, the applications 120 represent a journal application which provides digital content as an interactive canvas representative of pages of a journal. For example, a first page of the journal application can be displayed as digital content on touch surface 110 of display device 104 while a second page of the journal application is displayed as digital content on touch surface 112 of display device 106. The user can then write and draw on the interactive canvas with a stylus or the user's finger in order to generate additional digital content corresponding to the input, as well as insert and/or manipulate various different objects, such as by inserting images or videos, taking a photo with a camera of the client device 102, dragging an image displayed on a web browser to the interactive canvas, and so forth.

In at least some implementations, the applications 120 include or otherwise make use of an object insertion module 134. The object insertion module 134, for example, represents a standalone application. In other implementations, the object insertion module 134 is included as part of another application or system software, such as the operating system 118 or a journal application. Generally, the object insertion module 134 is configured to enable the insertion of objects into an interactive canvas in response to detection of user input to the interactive canvas corresponding to a closed shape. For example, a user can draw a closed shape on the interactive canvas in order to trigger the object insertion module 134 displaying an object insertion menu which enables the insertion of various types of objects (e.g., images, videos, or text) into the interactive canvas. Further discussion of this and other features is provided below.

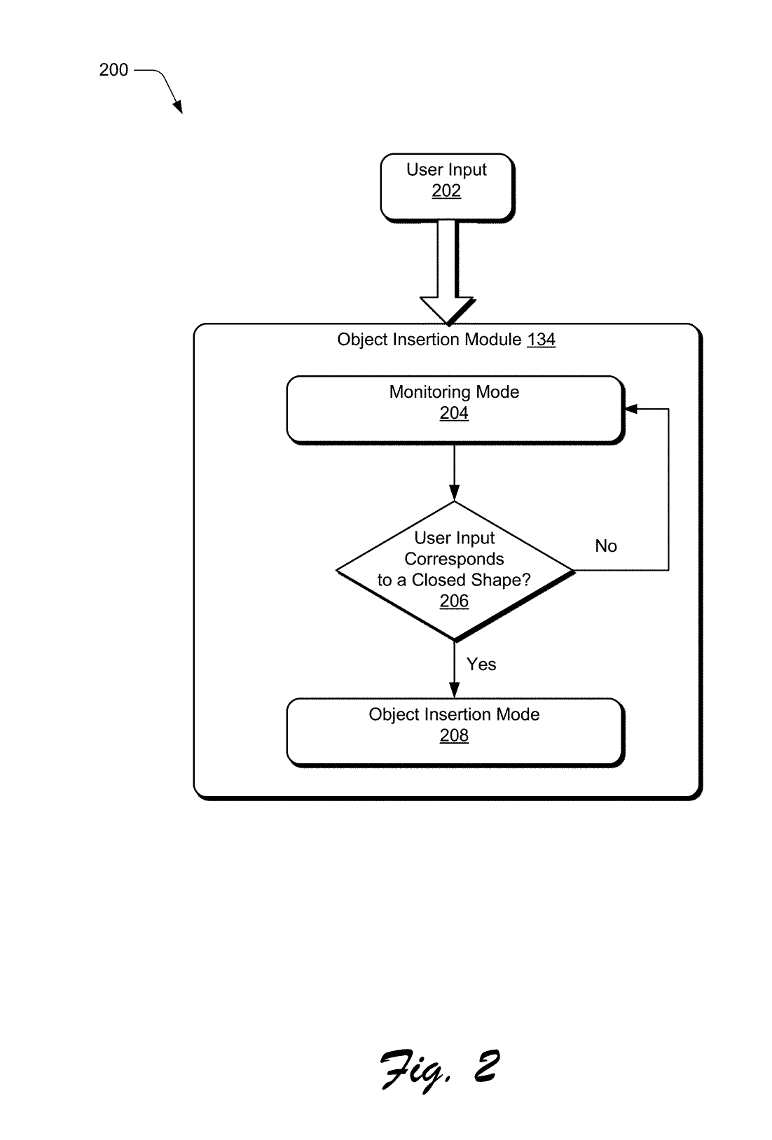

FIG. 2 illustrates a system 200 showing the object insertion module 134 in more detail.

In system 200, the object insertion module 134 monitors user input 202 to an interactive canvas in a monitoring mode 204. For example, a user can interact with an interactive canvas using a stylus, the user's finger, and so forth. At 206, the object insertion module 134 determines whether the user input 202 corresponds to a closed shape. If the user input does not correspond to a closed shape, then the object insertion module 134 remains in the monitoring mode. If, however, the user input 202 corresponds to a closed shape, then the object insertion module 134 initiates an object insertion mode 208.

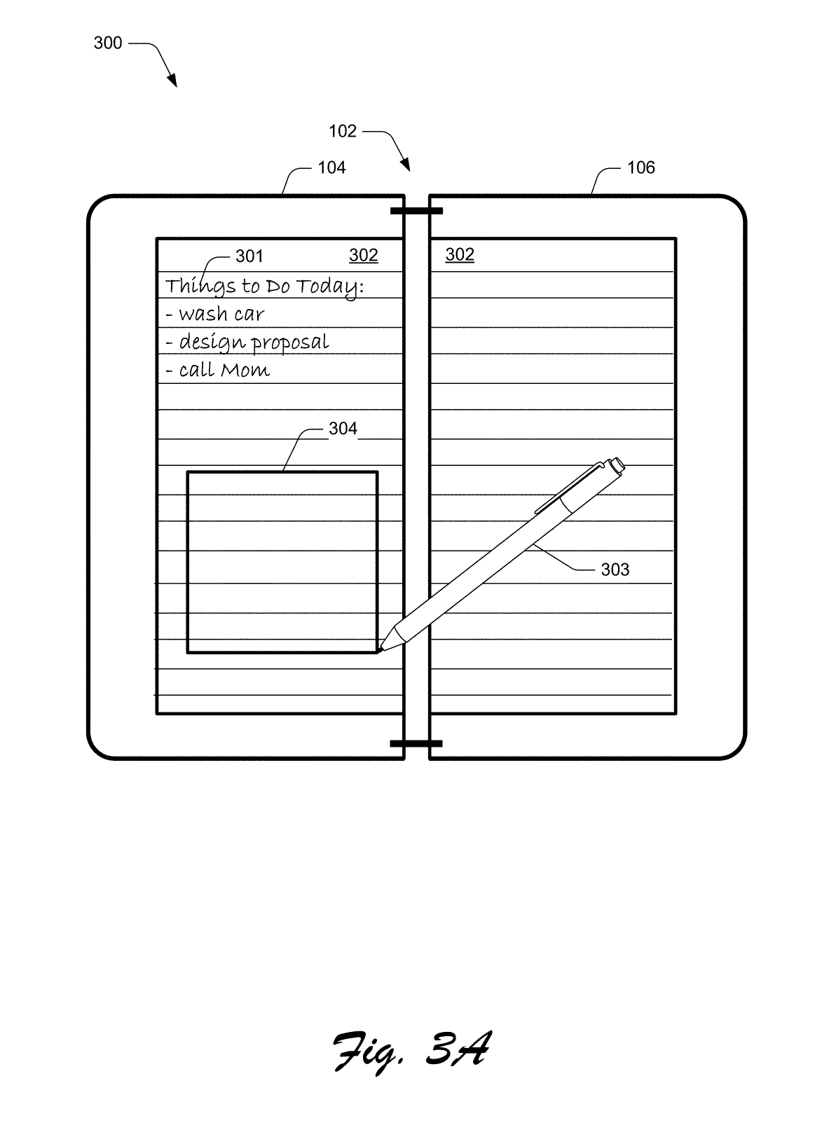

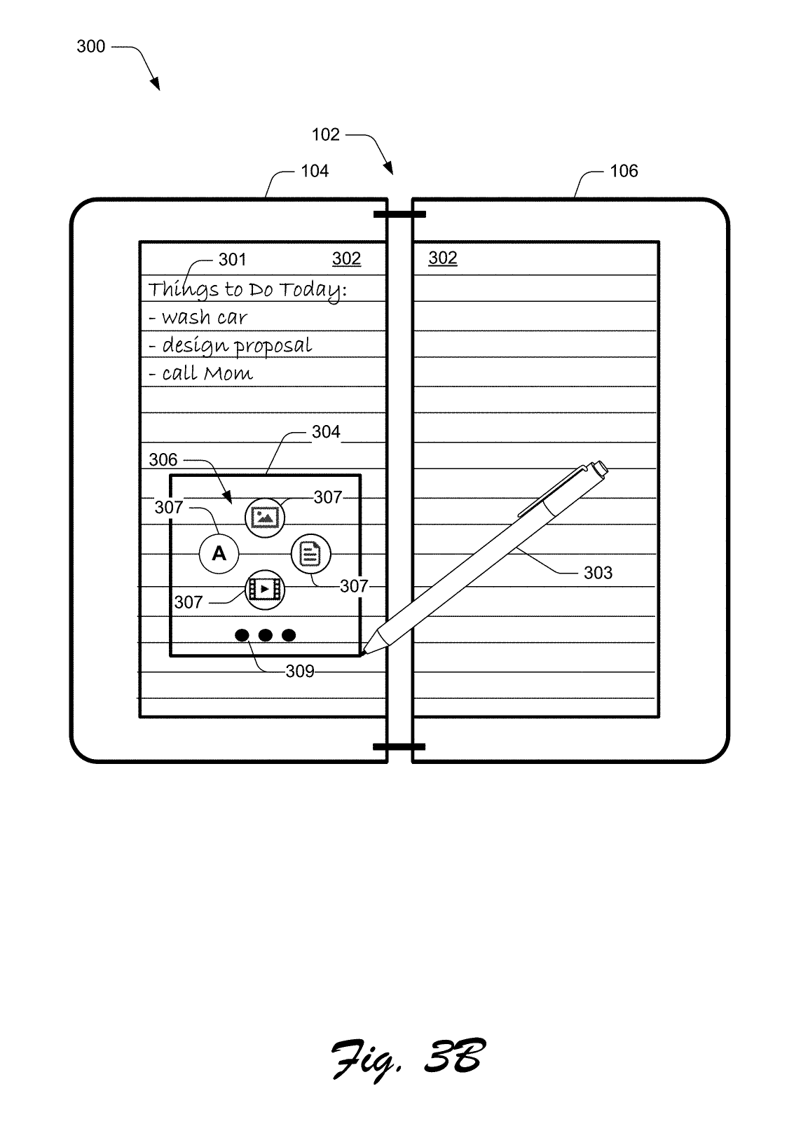

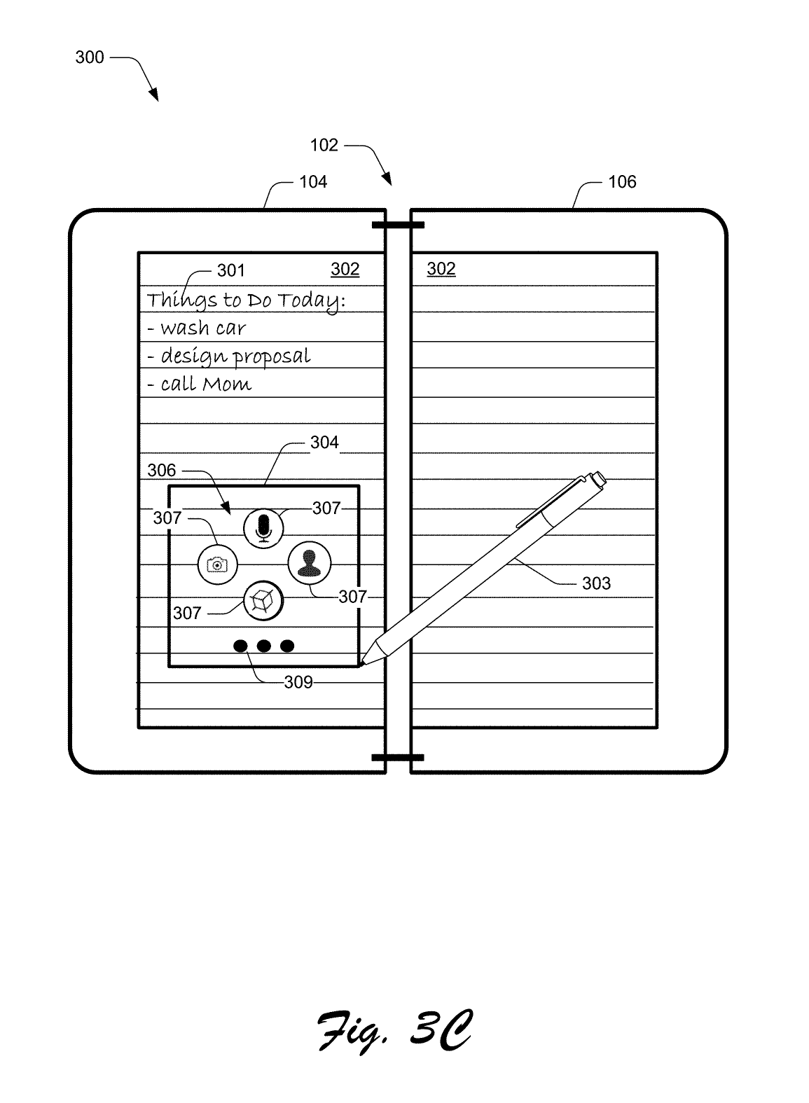

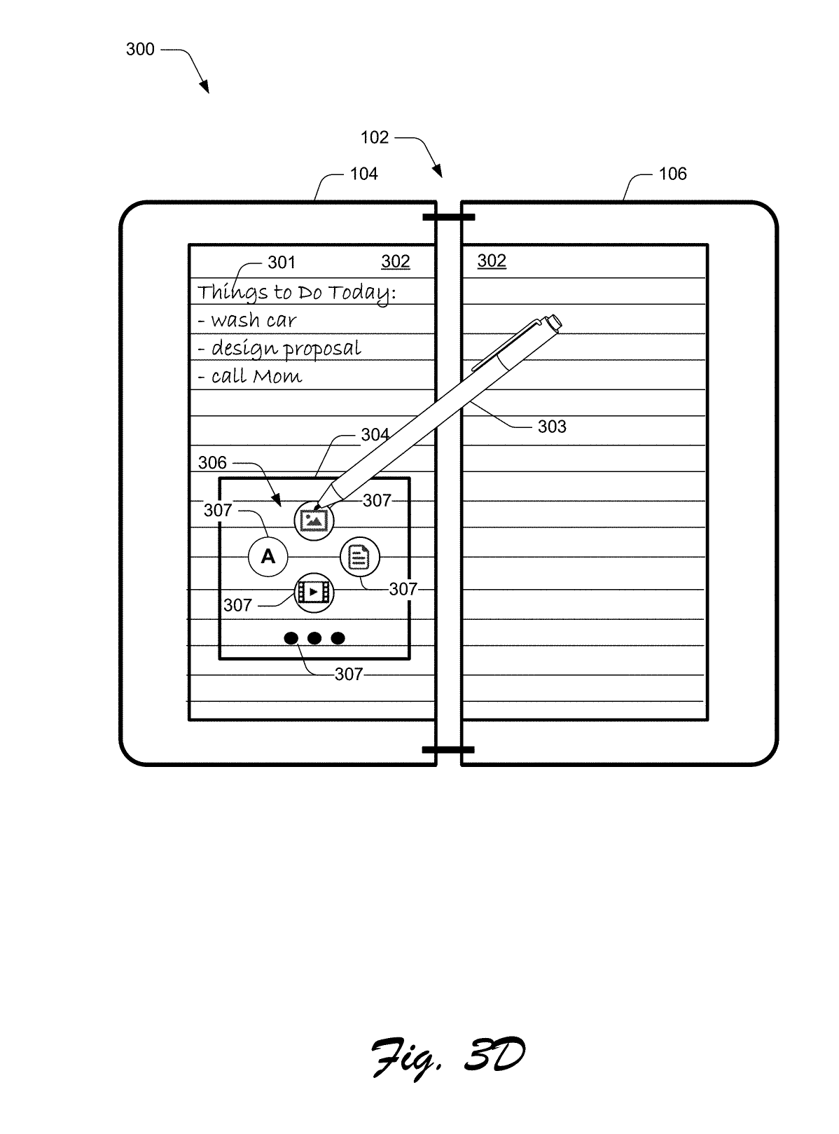

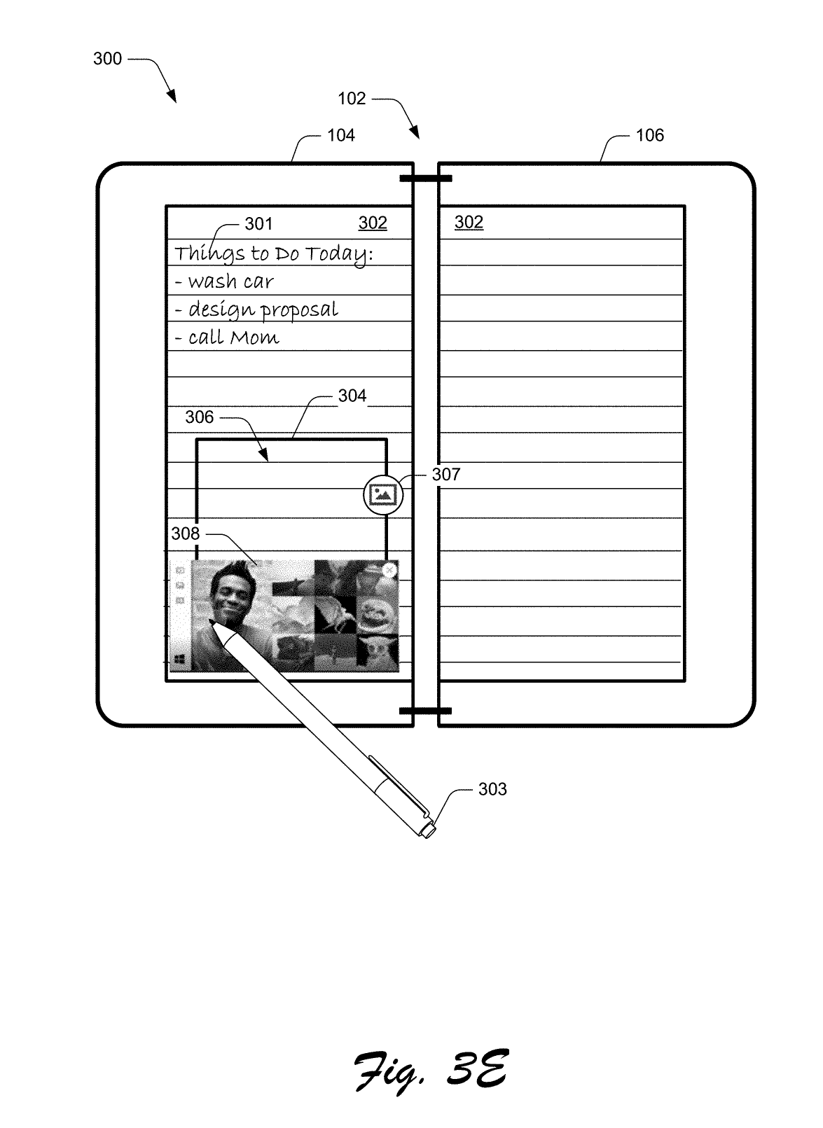

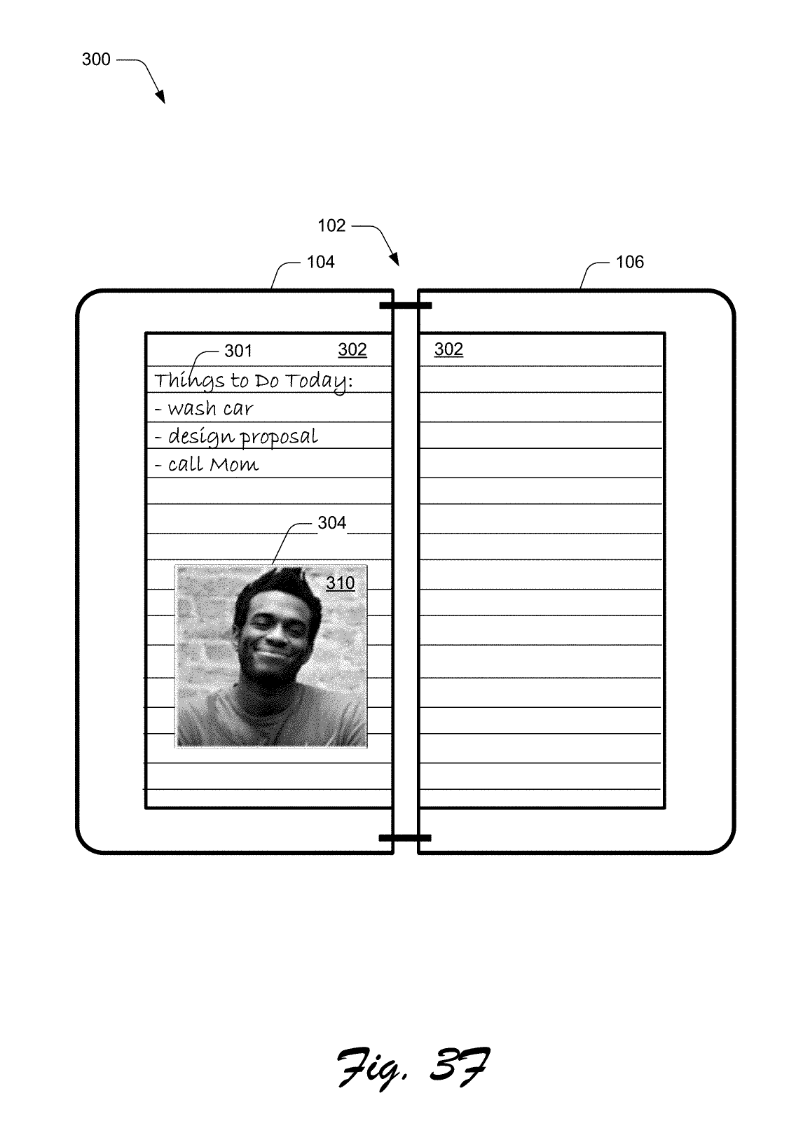

As an example, consider FIGS. 3A-3F which illustrate various examples 300 of object insertion in accordance with one or more implementations.

In FIG. 3A, client device 102 generates digital content as an interactive canvas 302, and displays the interactive canvas 302 on one or more display devices. In this example, the interactive canvas 302 is displayed across two display devices 104 and 106 of a “dual-display” client device 102, and is associated with a journal application. However, as described throughout, in other cases the interactive canvas 302 may be displayed on a “single-display” device and/or associated with a different type of application. The journal application enables the user to take notes and/or draw on the interactive canvas 302 using an input device, such as a stylus or the user's finger. In this example, user input is received to the interactive canvas when the user writes on the upper left corner of the interactive canvas 302 using a stylus 303, and in response the user input is digitized and displayed as additional digital content 301 on the interactive canvas 302.

In addition to enabling the user to write or draw on the interactive canvas 302, the interactive canvas 302 also enables the user to insert and manipulate various different types of objects. As described herein, objects may include any type of content, such as images and photos, videos, audio files, text, symbols, drawings, and so forth. One way in which the user can insert an object, is by writing or drawing on the interactive canvas 302 using a stylus or the user's finger. Another way in which the user can insert an object into interactive canvas 302, is by launching an application, such as a web browser, and dragging and dropping various images contained in web pages displayed by the web browser into the interactive canvas 302.

In addition, object insertion module 134 enables the user to quickly and efficiently insert an object into the interactive canvas by drawing a closed shape on the interactive canvas 302. As described herein, the closed shape may include various different types of defined geometric shapes, such as a circle, an ellipse, a square, a rectangle, a triangle, and so forth. In one or more implementations, the shape is inserted into the shape as drawn. Alternately, the system can detect the type of shape, and format a clean version of the shape. For example, the system can detect a square, and clean up the shape such as by making the lines straight, and the same size, and so forth.

In one or more implementations, the closed shape does not need to correspond to a defined geometric shape, but instead includes any “free-form” shape that is “closed”. Thus, the user can insert objects into a variety of different types of shapes without being limited to defined geometric shapes.

In one or more implementations, the object insertion module may be implemented to recognize “closed” shapes with a certain degree of error, such that the user may quickly draw a shape that is not closed by virtue of the ending drawing stroke of the shape not intersecting the beginning drawing stroke of the shape. In this case, the object insertion module 134 may recognize user intent to draw a closed shape due to a proximity of the beginning stroke to the end stroke, even though the strokes do not intersect on the interactive canvas.

In order to enable the insertion of objects, the object insertion module 134 monitors user input to interactive canvas 302 in the monitoring mode 204. In response to receiving the user input, the user input is digitized and displayed on the interactive canvas as additional digital content. The object insertion module 134 then detects whether the user input corresponds to a closed shape. In FIG. 3A for example, object insertion module 134 detects user input corresponding to a closed shape 304, which in this example is a square. Notably, the closed shape 304 is digitized and displayed on the interactive canvas 302 as additional digital content.

Additionally, in response to detection of user input corresponding to a closed shape, object insertion module 134 initiates the object insertion mode 208 which enables the user to quickly and efficiently insert an object into an area within the closed shape on the interactive canvas. Notably, the object insertion mode 208 can be triggered while the user is writing on the canvas, thereby enabling a seamless transition from writing or drawing on the interactive canvas 302 to inserting an object. In other words, the user does not need to first select a control to transition to the object insertion mode 208, but instead can quickly draw a closed shape on the interactive canvas.

In the object insertion mode 208, object insertion module 134 dynamically provides an object insertion menu. For example, in FIG. 3B, object insertion module 134 causes display of an object insertion menu 306 on the interactive canvas 302 in response to detection of the closed shape 304. In this example, the object insertion menu 306 is displayed within the additional digital content of the closed shape. However, the object insertion menu 306 may be displayed in a variety of different locations, such as proximate the closed shape on the interactive canvas 302, at a fixed location on the interactive canvas 302 (e.g., the upper right corner of the interactive canvas 302), and so forth. Displaying the object insertion menu 306 in a dynamic fashion enables the screen space of the client device 102 to be maximized because the space occupied by the object insertion menu 306 is not utilized until the object insertion mode 208 is triggered. Furthermore, in this example, the object insertion menu 306 is displayed within the closed shape 304, which ensures that the object insertion menu 306 will not overlap other objects or content in the interactive canvas 302.

The object insertion menu 212 enables insertion of various different types of objects or content into interactive canvas 302. Such objects may be stored on the client device 102 or remote from client device 102, such as at a cloud service associated with a user of the client device 102. Generally, the object insertion menu 212 includes selectable representations of multiple different types of objects which may be inserted into the interactive canvas within the closed shape, such as selectable representations to insert one or more images or photos, documents, text, videos, audio files, 3D models, and so forth.

In one or more implementations, the object insertion menu includes selectable representations corresponding to multiple different object types which may be inserted into the interactive canvas within the closed shape. For example, in FIG. 3B, the object insertion menu 306 includes selectable representations 307 which in this example corresponds to icons indicative of multiple different object types. In this example, the multiple different object types include photos, documents, videos, and text. The user may select one of the selectable representations of object insertion menu 306 in order to insert an object into the area within the closed shape 304.

In one or more implementations, the object insertion menu is configured to display selectable representations corresponding to a first subset of object types, and a navigation control that is selectable to causes display of additional selectable representations corresponding to at least a second subset of object types. In FIG. 3B, for example, the object insertion menu 306 displays a navigation control 309 which is represented by three dots, indicating that the object insertion menu can be controlled to display three different subsets of object types. For example, in FIG. 3C, the user has selected the navigation control 309 to scroll to a second subset of object types, which in this example includes an audio recording, a contact card, a 3D object, and a photo from a camera of the client device 102.

In one or more implementations, responsive to receiving a user selection of a representation 307 associated with an object type from the object insertion menu 306, the object insertion module 134 displays an object insertion control associated with the selected object type in the object insertion menu. The object insertion control includes additional selectable representations corresponding to the objects associated with the selected object type.

For example, in FIG. 3D, the user selects a selectable representation 307 corresponding to an object type of photos. In response, an object insertion control 308 associated with the object type for photos is displayed in the object insertion menu 306, which is illustrated in FIG. 3E. The object insertion control 308 includes additional selectable representations corresponding to an object type of photos which can be selected in order to insert the respective photo into the interactive canvas within the closed shape. For example, the photos may be stored on client device 102 and/or stored at one or more remote storage devices, and the additional selectable representations of the object insertion control 308 correspond to preview images of the photos. Notably, object insertion control may display any type of selectable representation corresponding to any type of object, such as videos, documents, and so forth.

In response to selection of an additional selectable representation from the object insertion control 308, the selected object is inserted into the interactive canvas 302 at an area within the closed shape. For example, in FIG. 3E, a photo of a man is selected by the user via user input from stylus 303. In FIG. 3F, in response to this selection, the object 310 corresponding to the photo of the man is inserted into the area within the closed shape 304 on the interactive canvas 302. In some cases, the object insertion module 134 can be implemented to edit the selected object to fit within the area inside the closed shape 304, such as by cropping, stretching, or re-sizing the selected object. In some cases, the object insertion module 134 causes an outline of the closed shape to remain on the interactive canvas. In this way, a visible outline of the closed shape is displayed around the inserted object. Alternately, the outline of the closed shape can be removed from the interactive canvas after the object is inserted.

In one or more implementations, the object insertion module 134 is configured to remove display of the object insertion menu 306 if the object insertion menu is not interacted with by the user within a certain period of time (e.g., 2 seconds, 5 seconds, and so forth). In some cases the object insertion mode can be canceled by the user via specific types of user input to the interactive canvas and/or the selection of a certain button on the stylus. For instance, the object insertion mode can be canceled in response to the user interacting with a portion of the interactive canvas other than the object insertion menu, such as by continuing to draw on the interactive canvas. In this case, display of the object insertion menu 306 is removed. In one or more implementations, if the object insertion mode is disabled without the user providing input to insert an object into the closed shape, the object insertion module 134 allows the digital content corresponding to the closed shape 304 to remain on the interactive canvas 302. In this way, the user is able to draw closed shapes on the interactive canvas 302.

In one or more implementations, the object insertion module 134 is configured to monitor a pattern of user input in order to temporarily disable the object insertion mode in response to determining that the user is currently drawing on the interactive canvas 302, and thus does not want to be constantly presented with display of the object insertion menu. Further, in one or more implementations, the object insertion mode 208 can be manually disabled by the user.

In one or more implementations, object insertion module 134 initiates the object insertion mode 208 in response to detection of user input corresponding to a closed shape that is also above a certain size threshold. The certain size threshold ensures that the user input corresponding to a particular shape is not intended to be writing input thereby ensuring that the object insertion mode is not triggered in response to the user writing the letter “O” or “D”, or any other letter, number, punctuation, or accent with a “closed” shape. In some cases, the particular size threshold may be dynamic based on the user's current writing. For example, if the user is writing small and suddenly draws a large circle, this will trigger the object insertion mode 208, whereas if the user is writing large and draws a large circle proximate the writing, this may be interpreted as an “O” by the object insertion module 134.

In one or more implementations, the object insertion module 134 enables the user to select one or more objects by drawing a closed shape around the one or more objects. In response to detecting user input that corresponds to a closed shape, one or more controls are displayed. The one or more controls are selectable to perform one or more respective operations on the one or more objects within the closed shape.

The one or more controls may be dynamically selected based on the objects within the closed shape. For example, the object insertion module 134 may determine a context or object type of the objects within the closed shape, and dynamically select the displayed controls based on the context or object type. For instance, if the one or more objects within the closed shape are pictures, then controls selectable to perform operations on pictures may be displayed, whereas if the one or more objects within the closed shape are videos, then controls selectable to perform operations on videos may be displayed. As another example, if the closed shape is drawn around a phone number that is written on the interactive canvas, the object insertion module 134 may surface one or more controls associated with creating or editing a contact card.

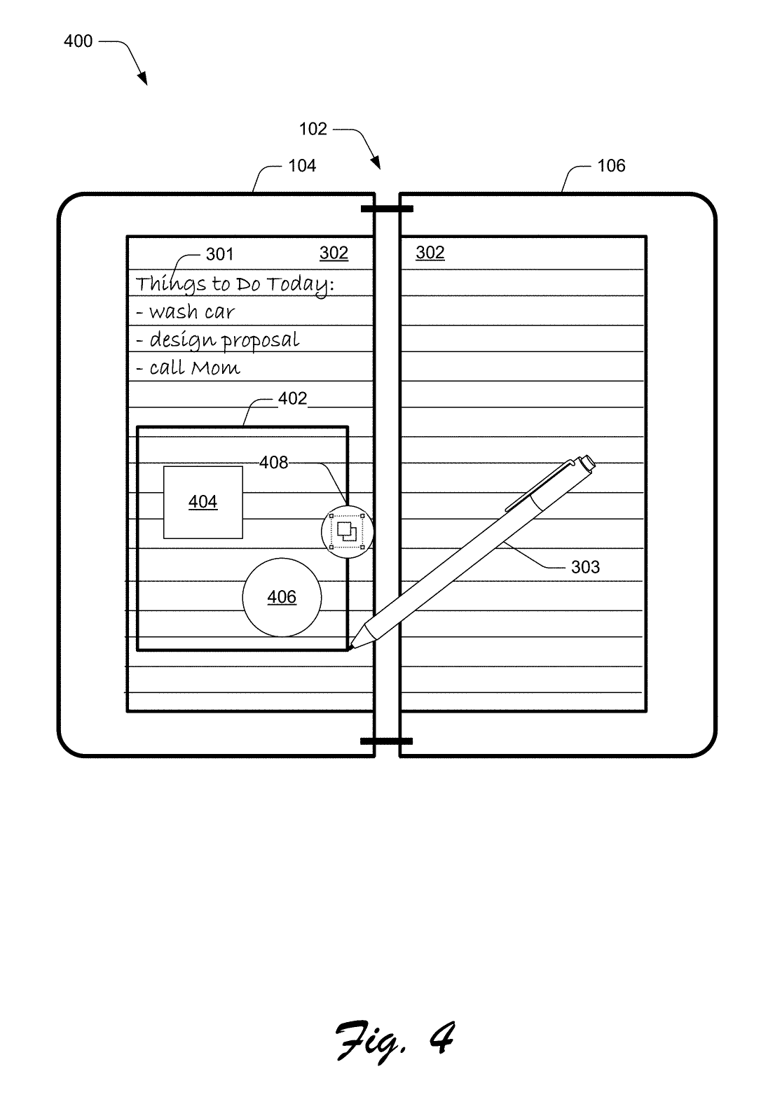

In some cases, the one or more controls may be selected to perform operations on multiple objects within the closed shape. For example, if multiple objects are within the closed shape, then controls selectable to perform operations on the objects within the closed shape may be displayed, such as a grouping control that causes the objects within the closed shape to be grouped together. As an example, consider FIG. 4 which illustrates an example 400 of drawing a closed shape around one or more objects. In this example, user input to draw a closed shape 402 around multiple objects 404 and 406 is received. In response to detecting that the user input corresponds to a closed shape that is drawn around objects 404 and 406, the object insertion module 134 displays one or more controls 408 associated with objects 404 and 406 within the closed shape 402. In this example, the controls 408 include a grouping control that can be selected in order to group objects 404 and 406.

The following discussion describes example procedures for object insertion in accordance with one or more embodiments. The example procedures may be employed in the environment 100 of FIG. 1, the system 800 of FIG. 8, and/or any other suitable environment. The procedures, for instance, represent procedures for implementing the example implementation scenarios discussed above.

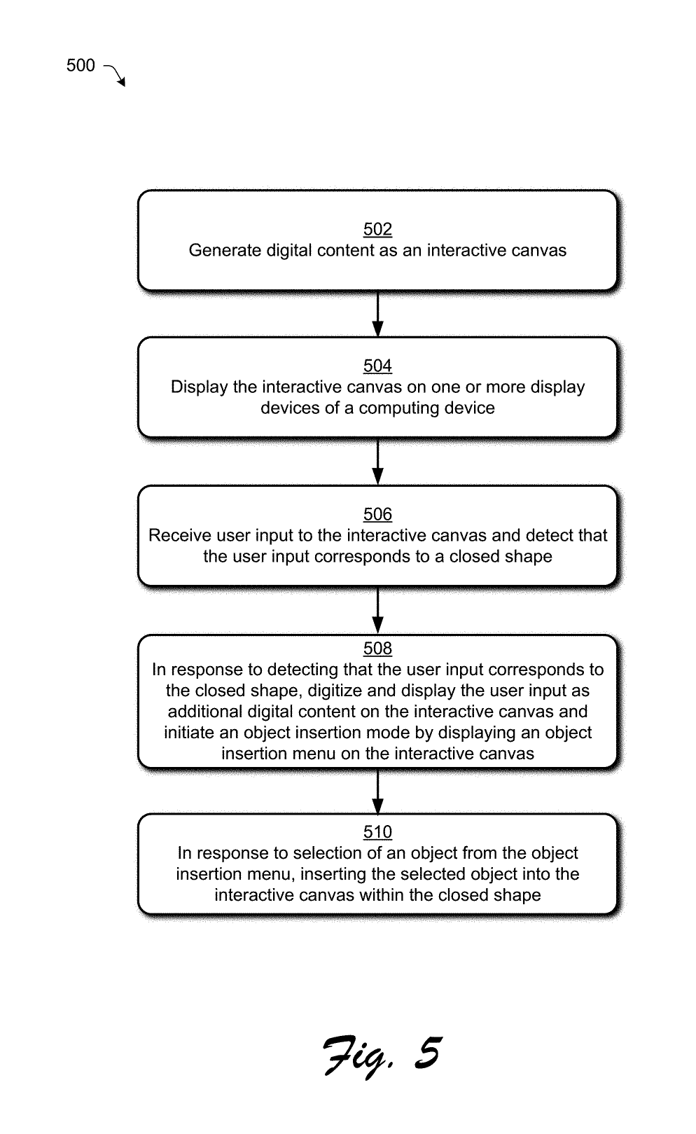

FIG. 5 is a flow diagram that describes steps in a method for inserting objects into an interactive canvas in accordance with one or more implementations.

At 502, digital content is generated as an interactive canvas, and at 504 the interactive canvas is displayed on one or more display devices of a computing device. For example, object insertion module 134 generates digital content as interactive canvas 302, and displays the interactive canvas on display device 104 and/or display device 106 of client device 102.

At 506, user input is received and the user input is detected as corresponding to a closed shape. For example, object insertion module 134 receives user input to the interactive canvas 302 and detects that the user input corresponds to a closed shape 304.

At 508, in response to detecting that the user input corresponds to the closed shape, the user input is digitized and displayed on the interactive canvas and an object insertion mode is initiated by displaying an object insertion menu on the interactive canvas. For example, object insertion module 134 digitizes and displays the user input corresponding to a closed shape 304 on the interactive canvas 302 and initiates object insertion mode 208 by displaying an object insertion menu 306 on the interactive canvas 302.

At 510, in response to selection of an object from the object insertion menu, the selected object is inserted into the interactive canvas within the closed shape. For example, in response to selection of a selectable representation from the corresponding to an object from the object insertion menu 306, the object 310 is inserted into the interactive canvas 302 within the closed shape 304. If an object is not selected from the object insertion menu within a certain period of time, then the object insertion module 134 may disable the object insertion mode 208 by removing the display of the object insertion menu 306. However, the object insertion module 134 enables the additional digital content corresponding to the closed shape 304 to remain on the interactive canvas 302.

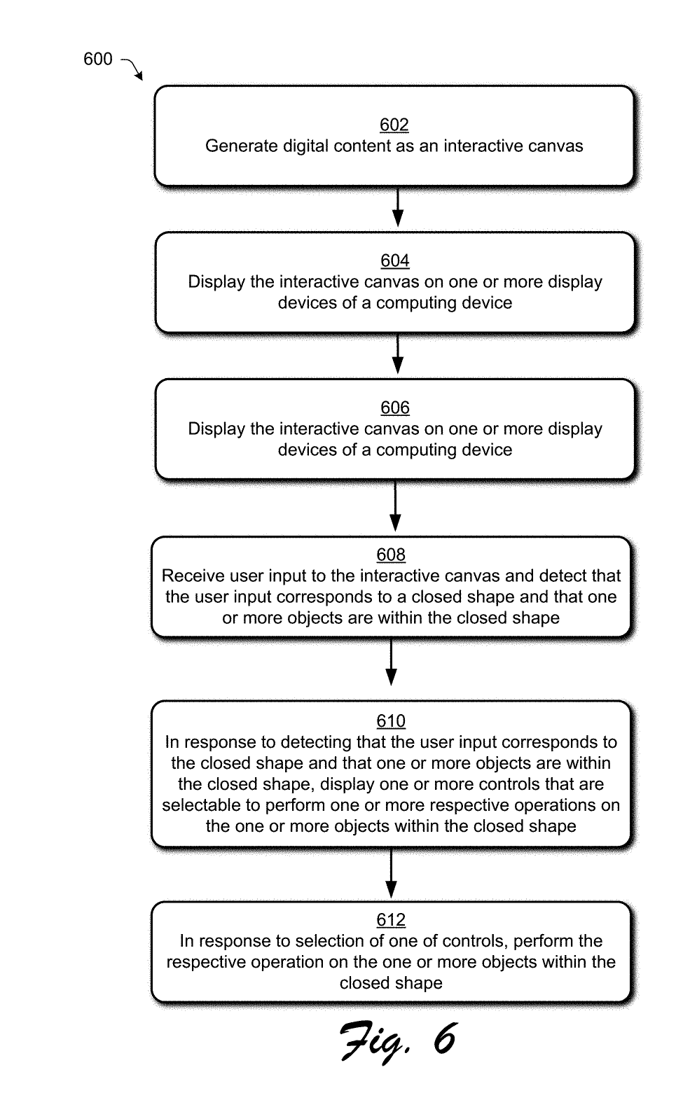

FIG. 6 is a flow diagram that describes steps in a method for displaying one or more controls that are selectable to perform operations on objects within a closed shape.

At 602, digital content is generated as an interactive canvas, and at 604 the interactive canvas is displayed on one or more display devices of a computing device. For example, object insertion module 134 generates digital content as interactive canvas 302, and displays the interactive canvas on display device 104 and/or display device 106 of client device 102.

At 606, one or more objects are displayed on the interactive canvas. For example, object insertion module 134 displays objects 404 and 406 on the interactive canvas.

At 608, user input is received and the user input is detected as corresponding to a closed shape and that one or more objects are within the closed shape. For example, object insertion module 134 receives user input to the interactive canvas 302 and detects that the user input corresponds to a closed shape 402 and that objects 404 and 406 are within the closed shape.

At 610, in response to detecting that the user input corresponds to a closed shape and that one or more objects are within the closed shape, one or more controls that are selectable to perform one or more respective operations on the one or more objects within the closed shape is displayed. For example, objects insertion module 134 displays one or more controls 408 which are selectable to perform one or more respective operations on objects 404 and 406 within the closed shape 402.

At 612, in response to selection of one of the controls, the respective operations is performed on the one or more objects within the closed shape. For example, object insertion module 134 performs the selected operation corresponding to the selected control 408 on objects 404 and 406 which are within the closed shape 402.

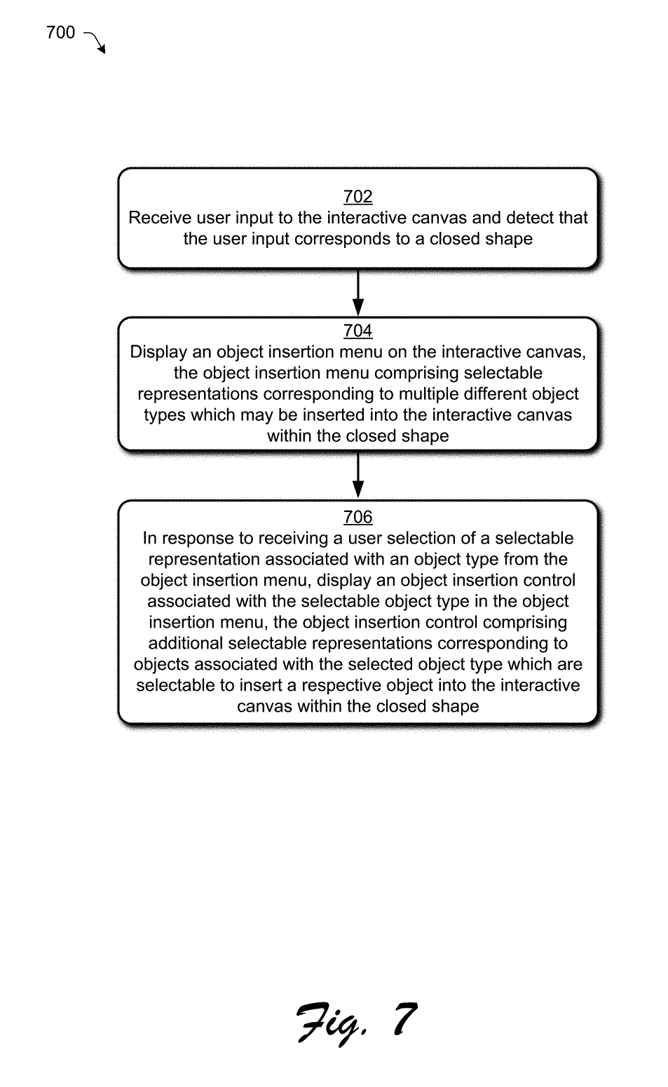

FIG. 7 is a flow diagram that describes steps in a method for displaying an object insertion menu in response to detecting user input corresponding to a closed shape in accordance with one or more implementations.

At 702, user input to an interactive canvas is received and the user input is detected as corresponding to a closed shape. For example, object insertion module 134 receives user input to the interactive canvas 302 and detects that the user input corresponds to a closed shape 304.

At 704, an object insertion menu is displayed on the interactive canvas, and includes selectable representations corresponding to multiple different object types which may be inserted into the interactive canvas within the closed shape. For example, object insertion module 134 displays an object insertion menu 306 which includes selectable representation 307 corresponding to multiple different object types which may be inserted into the interactive canvas 302 within the closed shape 304.

At 706, in response to receiving a user selection of a selectable representation associated with an object type from the object insertion menu, an object insertion control associated with the selected object type is displayed in the object insertion menu. The object insertion control includes additional selectable representations corresponding to objects associated with the selected object type which are selectable to insert a respective object into the interactive canvas within the closed shape. For example, in response to receiving a user selection of a selectable representation 307 associated with an object type from the object insertion menu 306, the object insertion module 134 displays an object insertion control 308 associated with the selected object type in the object insertion menu 306. The object insertion control includes additional selectable representations corresponding to objects associated with the selected object type which are selectable to insert a respective object into the interactive canvas within the closed shape.

FIG. 8 illustrates an example system generally at 800 that includes an example computing device 802 that is representative of one or more computing systems and/or devices that may implement the various techniques described herein. In at least some implementations, the computing device 802 represents an implementation of the client device 102 discussed above. The computing device 802 may, for example, be configured to assume a mobile configuration through use of a housing formed and sized to be grasped and carried by one or more hands of a user, illustrated examples of which include a mobile phone, mobile game and music device, and tablet computer although other examples are also contemplated. In at least some implementations, the client device 102 may be implemented as a wearable device, such as a smart watch, smart glasses, a dual-surface gesture-input peripheral for a computing device, and so forth.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media and does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

Example implementations described herein include, but are not limited to, one or any combinations of one or more of the following examples:

In one or more examples, a computing device comprises: one or more display devices; at least one processor; and at least one computer-readable storage media storing instructions that are executable by the at least one processor to: generate digital content as an interactive canvas; display the interactive canvas on the one or more display devices; monitor user input to an interactive canvas displayed on the one or more display devices; detect user input to the interactive canvas corresponding to a closed shape; in response to detection of the user input corresponding to the closed shape, digitize and display the user input as additional digital content on the interactive canvas and initiate an object insertion mode by displaying an object insertion menu on the interactive canvas; and in response to selection of an object from the object insertion menu, insert the selected object into the interactive canvas within the closed shape.

An example as described alone or in combination with any of the other examples described above or below, further comprising disabling the object insertion mode if an object is not selected from the object insertion menu within a certain period of time. An example as described alone or in combination with any of the other examples described above or below, further comprising enabling the additional digital content corresponding to the closed shape to remain on the interactive canvas.

An example as described alone or in combination with any of the other examples described above or below, wherein the object insertion mode is initiated if the user input corresponds to a closed shape and if the closed shape is above a certain size threshold.

An example as described alone or in combination with any of the other examples described above or below, wherein the object insertion mode is initiated if the user input corresponds to a closed shape that is drawn on a blank area of the interactive canvas.

An example as described alone or in combination with any of the other examples described above or below, further comprising instructions that are executable by the at least one processor to determine that the closed shape is drawn around one or more objects on the interactive canvas, and initiate the object insertion mode by displaying one or more controls associated with the one or more objects within the closed shape.

An example as described alone or in combination with any of the other examples described above or below, further comprising instructions that are executable by the at least one processor to monitor a pattern of user input and temporarily disable the object insertion mode if the pattern of user input indicates that the user is drawing on the interactive canvas.

An example as described alone or in combination with any of the other examples described above or below, wherein the selected object comprises an image, a video, an audio file, or text.

An example as described alone or in combination with any of the other examples described above or below, wherein the closed shape comprises a square, a rectangle, a circle, or a triangle, as well as non-convex shapes such as a star.

An example as described alone or in combination with any of the other examples described above or below, wherein the closed shape comprises a free-form shape.

An example as described alone or in combination with any of the other examples described above or below, wherein the digital content of the interactive canvas is displayed as pages of a journal application on a first and second display device of a dual display device.

In one or more examples, a method implemented by a computing device comprises: generating digital content as an interactive canvas; displaying the interactive canvas on one or more display devices of the computing device; receiving user input to the interactive canvas and detecting that the user input corresponds to a closed shape; in response to detecting that the user input corresponds to the closed shape, digitizing and displaying the user input as additional digital content on the interactive canvas and initiating an object insertion mode by displaying an object insertion menu on the interactive canvas; and in response to selection of an object from the object insertion menu, inserting the selected object into the interactive canvas within the closed shape.

An example as described alone or in combination with any of the other examples described above or below, further comprising digitizing and displaying the user input corresponding to the closed shape as additional digital content on the interactive canvas.

An example as described alone or in combination with any of the other examples described above or below, wherein the object insertion menu is displayed within the additional digital content of the closed shape

An example as described alone or in combination with any of the other examples described above or below, wherein the object insertion menu includes selectable representations corresponding to multiple different objects types which may be inserted into the interactive canvas within the closed shape.

An example as described alone or in combination with any of the other examples described above or below, wherein the object insertion menu displays selectable representations corresponding to a first subset of object types, and wherein the object insertion menu includes a navigation control that is selectable to cause display of additional selectable representations corresponding to at least a second subset of object types.

An example as described alone or in combination with any of the other examples described above or below, further comprising, responsive to receiving a user selection of a representation associated with an object type from the object insertion menu, displaying an object insertion control associated with the selected object type in the object insertion menu, the object insertion control comprising additional selectable representations corresponding to objects associated with the selected object type.

An example as described alone or in combination with any of the other examples described above or below, wherein the inserting comprises inserted the selected object into the interactive canvas within the closed shape in response to selection of a respective additional selectable representation corresponding to the objects associated with the selected object type.

In one or more examples, one or more computer-readable storage devices comprises instructions stored thereon that, responsive to execution by one or more processors of a computing device, perform operations comprising: generating digital content as an interactive canvas; displaying the interactive canvas on one or more display devices of a computing device; displaying, on the interactive canvas, one or more objects; receiving user input to the interactive canvas and detecting that the user input corresponds to a closed shape and that one or more objects are within the closed shape; and in response to detecting that the user input corresponds to a closed shape and that one or more objects are within the closed shape, displaying one or more controls that are selectable to perform one or more respective operations on the one or more objects within the closed shape.

An example as described alone or in combination with any of the other examples described above or below, wherein the detecting comprises detecting that multiple objects are within the closed shape, and wherein the selectable controls includes at least a grouping control that is selectable to group the multiple objects within the closed shape.

In one or more examples, a method implemented by a computing device comprises: receiving user input to an interactive canvas and detecting that the user input corresponds to a closed shape; displaying an object insertion menu on the interactive canvas, the object insertion menu comprising selectable representations corresponding to multiple different object types which may be inserted into the interactive canvas within the closed shape; and in response to receiving a user selection of a selectable representation associated with an object type from the object insertion menu, displaying an object insertion control associated with the selected object type in the object insertion menu, the object insertion control comprising additional selectable representations corresponding to objects associated with the selected object type which are selectable to insert a respective object into the interactive canvas within the closed shape.

An example as described alone or in combination with any of the other examples described above or below, further comprising receiving a user selection of one of the additional selectable representations and from the object insertion control and inserting the respective object associated with the selected additional selectable control into the interactive canvas within the closed shape.

An example as described alone or in combination with any of the other examples described above or below, wherein the object insertion menu displays selectable representations corresponding to a first subset of object types, and wherein the object insertion menu includes a navigation control that is selectable to cause display of additional selectable representations corresponding to at least a second subset of object types.

An example as described alone or in combination with any of the other examples described above or below, further comprising digitizing and displaying the user input corresponding to the closed shape on the interactive canvas.

An example as described alone or in combination with any of the other examples described above or below, wherein the object insertion menu is displayed within the closed shape.

An example as described alone or in combination with any of the other examples described above or below, wherein the object insertion menu is displayed proximate the closed shape on the interactive canvas.

An example as described alone or in combination with any of the other examples described above or below, wherein the object insertion menu is displayed at a fixed location of the interactive canvas.

An example as described alone or in combination with any of the other examples described above or below, further removing display of the object insertion menu if a selectable representation is not selected from the object insertion menu within a certain period of time.

An example as described alone or in combination with any of the other examples described above or below, further comprising enabling the closed shape to remain displayed on the interactive canvas.

An example as described alone or in combination with any of the other examples described above or below, wherein the selectable representations are associated with object types corresponding to at least two of photos, videos, text, or documents.

An example as described alone or in combination with any of the other examples described above or below, wherein the closed shape comprises a square, a rectangle, a circle, or a triangle.

An example as described alone or in combination with any of the other examples described above or below, wherein the closed shape comprises a free-form shape.

An example as described alone or in combination with any of the other examples described above or below, wherein the interactive canvas is displayed as pages of a journal application on a first and second display device of a dual display device.

In one or more examples, a computing device comprises: one or more display devices; at least one processor; and at least one computer-readable storage media storing instructions that are executable by the at least one processor to: receive user input to an interactive canvas displayed on the one or more display devices and detect that the user input corresponds to a closed shape; display an object insertion menu on the interactive canvas, the object insertion menu comprising selectable representations corresponding to multiple different object types which may be inserted into the interactive canvas within the closed shape; and in response to receiving a user selection of a selectable representation associated with an object type from the object insertion menu, display an object insertion control associated with the selected object type in the object insertion menu, the object insertion control comprising additional selectable representations corresponding to objects associated with the selected object type which are selectable to insert a respective object into the interactive canvas within the closed shape.

An example as described alone or in combination with any of the other examples described above or below, further comprising instructions that are executable by the at least one processor to receive a user selection of one of the additional selectable representations and from the object insertion control and insert the respective object associated with the selected additional selectable control into the interactive canvas within the closed shape.

An example as described alone or in combination with any of the other examples described above or below, wherein the object insertion menu displays selectable representations corresponding to a first subset of object types, and wherein the object insertion menu includes a navigation control that is selectable to cause display of additional selectable representations corresponding to at least a second subset of object types.

An example as described alone or in combination with any of the other examples described above or below, further comprising digitizing and displaying the user input corresponding to the closed shape on the interactive canvas.

An example as described alone or in combination with any of the other examples described above or below, wherein the object insertion menu is displayed within the closed shape.

An example as described alone or in combination with any of the other examples described above or below, wherein the object insertion menu is displayed proximate the closed shape on the interactive canvas.

An example as described alone or in combination with any of the other examples described above or below, wherein the object insertion menu is displayed at a fixed location of the interactive canvas.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device comprising:
one or more display devices;
at least one processor; and
at least one computer-readable storage media storing instructions that are executable by the at least one processor to:
generate digital content as an interactive canvas;
display the interactive canvas on the one or more display devices;
monitor user input to an interactive canvas displayed on the one or more display devices;
detect user input to the interactive canvas corresponding to a closed shape;
in response to detection of the user input corresponding to the closed shape, digitize and display the user input as additional digital content on the interactive canvas and initiate an object insertion mode by displaying an object insertion menu on the interactive canvas; and
in response to selection of an object from the object insertion menu, insert the selected object into the interactive canvas within the closed shape.

2. The computing device of claim 1, further comprising disabling the object insertion mode if an object is not selected from the object insertion menu within a certain period of time.

3. The computing device of claim 2, further comprising causing the additional digital content corresponding to the closed shape to remain on the interactive canvas after the object insertion mode is disabled.

4. The computing device of claim 1, wherein the object insertion mode is initiated if the user input corresponds to a closed shape and if the closed shape is above a certain size threshold.

5. The computing device of claim 1, wherein the object insertion mode is initiated if the user input corresponds to a closed shape that is drawn on a blank area of the interactive canvas such that no objects are within an outline of the closed shape.

6. The computing device of claim 1, further comprising instructions that are executable by the at least one processor to determine that the closed shape is drawn around one or more objects on the interactive canvas, and initiate the object insertion mode by displaying one or more controls associated with the one or more objects within the closed shape.

7. The computing device of claim 1, further comprising instructions that are executable by the at least one processor to monitor a pattern of user input and temporarily disable the object insertion mode if the pattern of user input indicates that the user is drawing on the interactive canvas.

8. The computing device of claim 1, wherein the selected object comprises an image, a video, an audio file, or text.

9. The computing device of claim 1, wherein the closed shape comprises a square, a rectangle, a circle, an ellipse, or a triangle.

10. The computing device of claim 1, wherein the closed shape comprises a free-form shape.

11. The computing device of claim 1, wherein the digital content of the interactive canvas is displayed as pages of a journal application on a first and second display device of a dual display device.

12. A method implemented by a computing device, the method comprising:
generating digital content as an interactive canvas;
displaying the interactive canvas on one or more display devices of the computing device;
receiving user input to the interactive canvas and detecting that the user input corresponds to a closed shape;
in response to detecting that the user input corresponds to the closed shape, digitizing and displaying the user input as additional digital content on the interactive canvas and initiating an object insertion mode by displaying an object insertion menu on the interactive canvas; and
in response to selection of an object from the object insertion menu, inserting the selected object into the interactive canvas within the closed shape.

13. The method of claim 12, further comprising digitizing and displaying the user input corresponding to the closed shape as additional digital content on the interactive canvas.

14. The method of claim 13, wherein the object insertion menu is displayed within the additional digital content of the closed shape

15. The method of claim 12, wherein the object insertion menu includes selectable representations corresponding to multiple different objects types which may be inserted into the interactive canvas within the closed shape.

16. The method of claim 15, wherein the object insertion menu displays selectable representations corresponding to a first subset of object types, and wherein the object insertion menu includes a navigation control that is selectable to cause display of additional selectable representations corresponding to at least a second subset of object types.

17. The method of claim 15, further comprising, responsive to receiving a user selection of a representation associated with an object type from the object insertion menu, displaying an object insertion control associated with the selected object type in the object insertion menu, the object insertion control comprising additional selectable representations corresponding to objects associated with the selected object type.

18. The method of claim 17, wherein the inserting comprises inserted the selected object into the interactive canvas within the closed shape in response to selection of a respective additional selectable representation corresponding to the objects associated with the selected object type.

19. One or more computer-readable storage devices comprising instructions stored thereon that, responsive to execution by one or more processors of a computing device, perform operations comprising:
generating digital content as an interactive canvas;
displaying the interactive canvas on one or more display devices of a computing device;
displaying, on the interactive canvas, one or more objects;
receiving user input to the interactive canvas and detecting that the user input corresponds to a closed shape and that one or more objects are within the closed shape; and
in response to detecting that the user input corresponds to a closed shape and that one or more objects are within the closed shape, displaying one or more controls that are selectable to perform one or more respective operations on the one or more objects within the closed shape.

20. The one or more computer-readable storage devices of claim 19, wherein the detecting comprises detecting that multiple objects are within the closed shape, and wherein the selectable controls include at least a grouping control that is selectable to group the multiple objects within the closed shape.
